(19) United States
(12) Patent Application Publication
(10) Pub. No.: US 2023/0218127 A1
(43) Pub. Date: Jul. 13, 2023

(54) TOILET CLEANING TOOL, DRIVING METHOD AND BRUSH ELEMENT REPLACEMENT METHOD

(71) Applicant: TRANZERO B.V., Zoetermeer (NL)

(72) Inventors: Dennis Gerardus Karel Maria LUITEN, Zoetermeer (NL); Hidde Frank REITSMA, Zoetermeer (NL)

(21) Appl. No.: 18/009,606

(22) PCT Filed: Jun. 9, 2021
(86) PCT No.: PCT/NL2021/050368

§ 371 Date: Dec. 9, 2022

(30) Foreign Application Priority Data
Jun. 9, 2020 (NL) 2025797

(51) Int. Cl. A47K 11/10; B08B 3/12; A46B 5/00; A46B 13/02; A46B 9/02; A46B 15/00; B06B 1/02; B06B 1/06

(52) U.S. Cl. CPC A47K 11/10; B08B 3/12; A46B 5/0095; A46B 13/023; A46B 9/026; A46B 15/0004; B06B 1/0261; B06B 1/0611; A46B 2200/304; B06B 2201/55; B06B 2201/71

(57) ABSTRACT

The invention relates to a toilet cleaning tool comprising:
a handle;
a vibration member attached at a free end of the handle, wherein said vibration member includes an emitting surface for emitting vibrational waves;
   wherein the toilet cleaning tool further includes one or more spacers arranged around the vibration member to keep the vibration member free of the toilet bowl during cleaning.

### BACKGROUND OF THE INVENTION

The invention relates to a toilet cleaning tool.

Toilet cleaning tools, also known as lavatory cleaning tools, such as toilet brushes are widely known and used. However, although there exist many different designs of the toilet brush, they typically include a hard-bristled end, usually with a rounded shape, and a long handle.

A very well-known problem is that biological debris may be very stubborn so that even after cleaning with a toilet brush, a residue may be left behind in a toilet bowl. Another well-known problem is that after cleaning, a residue of the biological debris is left behind on the bristles. As a result, the visual appearance of the toilet bowl may be unsatisfactory and smells, germs, and/or other unpleasantries may be released.

Different approaches have been tried to improve the cleaning performance of a toilet brush as well as improve the hygiene of the toilet brush. These approaches include:
Mechanizing the toilet brush by fastening the bristles on the rotor of a motor similar to an electric toothbrush or to vibrate the bristles using ultrasonic energy from a generator as for instance disclosed in DE202004019618U1 or U.S. Pat. No. 8,209,790B1;
Using chemical toilet cleaning products;
Innovative holders that snap shut around the bristled end, thereby preventing the release of smells, germs and other unpleasantries;
Using a reservoir of anti-bacterial fluid allowing the brush to be dipped and sanitized after each use; and
A self-cleaning toilet brush using a brush holder with a fluid connection to the water tank of a toilet to take advantage of clean water and another fluid connection running into the toilet bowl for proper draining, so that when the toilet is flushed, the brush holder fills up with clean water while simultaneously draining the dirty water into the toilet bowl.

However, these approaches have not led to a satisfactory performance.

One other mechanizing solution is disclosed in JPH1015510A in which mere ultrasound is used for cleaning the toilet bowl. However, this solution was never adopted by the consumers as cleaning performance was highly dependent on the skills of the user operating this toilet cleaning tool. Bad or low skills resulted in a lot of noise, damage to the toilet cleaning tool or the toilet bowl, and/or residue still remaining in the toilet bowl.

CN2750793Y discloses a combination of the solution in JPH1015510A and the solution of DE202004019618U1 or U.S. Pat. No. 8,209,790B1, by using a generator to vibrate the bristles and at the same time direct ultrasonic energy into a liquid using protrusions in between the bristles.

### SUMMARY OF THE INVENTION

In view of the above it is an object of the invention to provide a toilet cleaning tool that is easy to use and has sufficient cleaning performance and/or hygiene.

According to a first aspect of the invention, there is provided a toilet cleaning tool comprising:
a handle;
a vibration member attached at a free end of the handle, wherein said vibration member includes an emitting surface for emitting vibrational waves;
   wherein the toilet cleaning tool further includes one or more spacers arranged around the vibration member to keep the vibration member free of the toilet bowl during cleaning, preferably in one direction, more preferably in two orthogonal directions, and most preferably in three orthogonal directions.

An advantage of the toilet cleaning tool according to the first aspect of the invention is that during use the one or more spacers prevent the vibration member from directly or indirectly contacting the toilet bowl during cleaning, making it easier to clean, but also increase hygiene as no contact means also a reduced risk of biological residue transfer. Hence, compared to the prior art, the one or more spacers arranged around the vibration member are not configured to emit vibrational waves and thus the bristles vibrated in the prior art are not considered to be one or more spacers according to the invention.

In an embodiment, the vibration member is configured to emit ultrasonic vibrational waves, preferably in order to cause cavitation in water of a toilet bowl.

In an embodiment, the one or more spacers are provided at a larger radius from a longitudinal axis of the handle than the emitting surface. An advantage is that the one or more spacers prevent contact in a sideways direction.

In an embodiment, the one or more spacers extend from the handle beyond the emitting surface in a direction parallel to a longitudinal axis of the handle. An advantage is that the one or more spacers prevent contact in a direction parallel to the longitudinal axis.

In an embodiment, the one or more spacers define a circumscribed polygon and the emitting surface is arranged inside a circle inscribed in the polygon.

In an embodiment, the one or more spacers include a ring member.

In an embodiment, the one or more spacers include bristles. An advantage thereof is that the bristles provide an alternative or additional means of cleaning a toilet bowl.

In an embodiment, the bristles extend mainly perpendicular to a longitudinal axis of the handle.

In an embodiment, the one or more spacers are at least partially replaceable. This allows to keep hygiene of the toilet cleaning tool high without having to replace the entire tool, but only a part thereof that has a high risk of getting dirty. As the one or more spacers are the parts with the highest risk of contacting biological debris or residue, replacing at least a part thereof may increase the hygiene level.

In an embodiment the one or more spacers include a fragrance element. This allows to suppress or mask bad odors from the one or more spacers. The fragrance element may be replaceable. Alternatively, or additionally, replacing at least a part of the one or more spacers may include replacing the fragrance element at the same time.

In an embodiment, the vibration member is configured to emit vibrational waves substantially in a first direction, also including emitting of vibrational waves in a diverging cone having a central axis in the first direction and an aperture of at most 90 degrees, preferably at most 60 degrees, more preferably at most 45 degrees, and most preferably at most 30 degrees.

In an embodiment, the vibration member is configured to emit vibrational waves substantially in a second direction different from the first direction, also including emitting of vibrational waves in a diverging cone having a central axis in the second direction and an aperture of at most 90 degrees, preferably at most 60 degrees, more preferably at most 45 degrees, and most preferably at most 30 degrees.

In an embodiment, the second direction is substantially opposite to the first direction. In an embodiment, the vibration member includes a head including a primary emitting surface at one side and a secondary emitting surface at an opposite side.

In an embodiment, the head is configured to emit vibrational waves of a predetermined frequency at the primary emitting surface in a predetermined phase relationship with the vibrational waves emitted at the secondary emitting surface. This allows to optimize the shape of the head to a predetermined frequency so that the different vibrational waves amplify each other instead of attenuating each other for a predetermined location or location range.

In an embodiment, the vibration member may include a horn or horn-like shape adjacent the emitting surface or adjacent a portion including the emitting surface.

In an embodiment, the one or more spacers are positioned such that they do not significantly interfere with the emitting of the vibrational waves, e.g. the one or more spacers are arranged outside the aforementioned diverging cone.

In other words, when the vibration member is configured to emit vibrational waves in a diverging cone, the one or more spacers are configured to allow unobstructed passage of the vibrational waves in the diverging cone. The one or more spacers may therefore include holes, openings, passageways, cutaways, etc. to allow the passage of the vibrational waves while performing its function of direct or indirect contact between the vibrational member and the toilet bowl.

In an embodiment, the one or more spacers are dynamically decoupled from the vibration member below a predetermined frequency to avoid vibrational waves to travel from the vibration member to the one or more spacers via the toilet cleaning tool itself.

In an embodiment, the one or more spacers are configured such that the vibration member causes standing waves in the one or more spacers and the location of the one or more spacers used to engage with a toilet bowl are at a node of the standing waves thereby preventing the vibrational waves from being transferred to the toilet bowl via the one or more spacers.

The invention according to the first aspect of the invention also relates to a method for operating the toilet cleaning tool according to the first aspect of the invention, wherein the method comprises the following steps:
a. driving the vibration member to emit vibrational waves from the emitting surface; and
b. keeping the vibration member free from a toilet bowl during cleaning of the toilet bowl by allowing the one or more spacers to engage with the toilet bowl.

In an embodiment, the method further comprises the following steps:
c. detaching at least a part of the one or more spacers;
d. re-attaching at least a part of one or more spacers.

The detached components in step c. may be cleaned and subsequently be re-attached in step d., but it is also possible that one or more of the detached components are replaced by “new” components.

According to a second aspect of the invention, there is provided a toilet cleaning tool comprising:
a handle;
a vibration member attached at a free end of the handle, wherein said vibration member includes an emitting surface for emitting vibrational waves; and
a control unit for driving the vibration member,
   wherein toilet cleaning tool comprises a sensor for measuring a parameter associated with the vibration member,
   and wherein the control unit is configured to determine a resonance frequency of the vibration member based on an output of the sensor and to drive the vibration member at the resonance frequency.

An advantage of the toilet cleaning tool according to the second aspect of the invention is that the resonance frequency can be optimized based on the surrounding conditions and/or based on the state of the toilet cleaning tool itself. Another advantage may be that it may be possible to detect whether the vibration member is submerged in water or still in the air, thereby providing the possibility to only vibrate in water and to stop vibrating in air, thereby saving energy and/or preventing damage to the vibration member.

In an embodiment, the vibration member includes a piezoelectric transducer and the sensor is configured to measure a current supplied to the piezoelectric transducer.

In an embodiment, the sensor is configured to measure strain in the vibration member as parameter, e.g. using a strain gauge and measuring the electrical resistance thereof.

In an embodiment, the sensor is a piezoelectric transducer that is part of the vibration member and that is configured to measure deformation of the transducer as parameter.

In an embodiment, the control unit is configured to determine the resonance frequency regularly during use.

In an embodiment, the control unit is configured to stop driving the vibration member when the determined resonance frequency is outside a predetermined frequency range.

The third aspect of the invention also relates to a method for driving a toilet cleaning tool according to the third aspect of the invention, wherein the method comprises the following steps:
a. measuring a parameter associated with the vibration member;
b. determining a resonance frequency of the vibration member based on the measured parameter; and
c. driving the vibration member at the determined resonance frequency.

In an embodiment, the parameter is measured for a plurality of frequencies in a predetermined range, i.e. using a sweep, and the resonance frequency is determined based on the measured parameter for the plurality of frequencies.

In an embodiment, the parameter is measured for a predetermined starting frequency and the frequency is adjusted in a direction in which the parameter increases, and wherein adjusting the frequency is carried out as along as the parameter increases and stops when parameter starts to decrease to determine the resonance frequency.

In an embodiment, the sensor may be configured to measure a current supplied to a piezoelectric transducer that is part of the vibration member as parameter.

In an embodiment, the measured parameter is representative for an amplitude of the vibrational waves emitted by the vibration member, e.g. current, voltage, strain, stress, etc.

In an embodiment, the method further comprises the following steps:
d. determining whether the resonance frequency is in a predetermined frequency range; and
e. stopping driving the vibration member when the resonance frequency is outside the predetermined frequency range.

According to a third aspect of the invention, there is provided a toilet cleaning tool, comprising:
a handle; and
a vibration member attached at a free end of the handle, wherein said vibration member includes an emitting surface for emitting vibrational waves,
   wherein the vibration member includes a first mass, a piezoelectric transducer, and a counter mass,
   wherein the first mass extends from the handle and forms the emitting surface, wherein the piezoelectric transducer is arranged in between the first mass and the counter mass,
   and wherein the vibration member is connected to the handle via a resilient connection element that is configured to attenuate vibrational waves, i.e. vibrations, generated by the piezoelectric transducer and transferred to the handle.

In an embodiment, the connection element is configured to seal a space between the vibration member and the handle to prevent fluid from entering the handle.

In an embodiment, the connection element is arranged between the counter mass and the handle. Alternatively, or additionally, the connection element is arranged between the first mass and the handle. Hence, in an embodiment, two resilient connection elements may be provided, one between the counter mass and the handle, and another one between the first mass and the handle.

In an embodiment, the connection element comprises rubber, e.g. in the form of a rubber ring.

In an embodiment, the piezoelectric transducer is a stack of piezoelectric actuators.

According to a fourth aspect of the invention, there is provided a toilet cleaning tool comprising:
a handle; and
a brush element releasably connected to a free end of the handle using one or more connection elements,
   wherein the brush element is replaceable,
   wherein the brush element has a ring shape with a center hole,
   and wherein the one or more connection elements and the brush element are configured such that when a new brush element is positioned over the handle and engages with the one or more connection elements, the present brush element is released thereby making room for the new brush element to be attached.

An advantage of the toilet cleaning tool according to the fourth aspect is that replacing the “old” brush element with a new brush element can be done in a single operation while only handling the new brush element and without touching the “old”, possibly dirty, brush element. The handle is then passed through the center hole and may thus have a cross-section smaller than the center hole or the handle may be adjustable to temporary have a cross-section that is smaller than the center hole to allow the brush element to pass, e.g. by allowing a battery compartment or other component to be temporary removed.

In an embodiment, the one or more connection elements are formed by resilient beams attached with one end to the handle and with the other end to the brush element.

In an embodiment, the one or more connection elements include snap-fit connection portions to engage with the brush element.

The fourth aspect of the invention also relates to a method for replacing a brush element of a toilet cleaning tool according to the fourth aspect of the invention, wherein the method comprises the following steps:
a. positioning a new brush element over the handle;
b. allowing the new brush element to engage with the one or more connection elements to release the present brush element; and
c. connecting the new brush element to the one or more connection elements.

In an embodiment, positioning a new brush element over the handle and allowing the new brush element to engage with the one or more connection elements may be carried out after removing a portion of the handle, e.g. a battery compartment, to temporary reduce a cross-section of at least a part of the handle thereby allowing to let the new brush element pass.

It is explicitly noted here that the same method may be used for a ring-shaped spacer as described by reference to the first aspect of the invention instead of a brush element.

It is explicitly noted here that embodiments and/or features described in relation to one aspect of the invention may be readily combined with embodiments and/or features of other aspects of the invention, where applicable, in order to prevent unduly repetition of these embodiments and/or features. Examples of such combinations are provided below by reference to the drawings.

### BRIEF DESCRIPTION OF THE DRAWINGS

The invention will now be described in a non-limiting way by reference to the accompanying drawings in which like parts are indicated by like reference symbols, and in which:

FIG. 1 schematically depicts a cross-sectional view of a toilet cleaning tool according to an embodiment of the invention;

FIG. 2 schematically depicts a bottom view of the toilet cleaning tool of FIG. 1;

FIG. 3 schematically depicts a bottom view of a toilet cleaning tool according to another embodiment of the invention;

FIG. 4A schematically depicts a bottom view of a toilet cleaning tool according to a further embodiment of the invention;

FIG. 4B schematically depicts a lower portion of the toilet cleaning tool of FIG. 4A;

FIG. 5 schematically depicts a diagram of current as a function of frequency;

FIG. 6 schematically depicts a flow chart of a method according to an embodiment of the invention;

FIG. 7 schematically depicts a free end of a vibration member according to an embodiment of the invention; and

FIG. 8 schematically depicts a free end of a vibration member according to another embodiment of the invention.

### DETAILED DESCRIPTION OF THE INVENTION

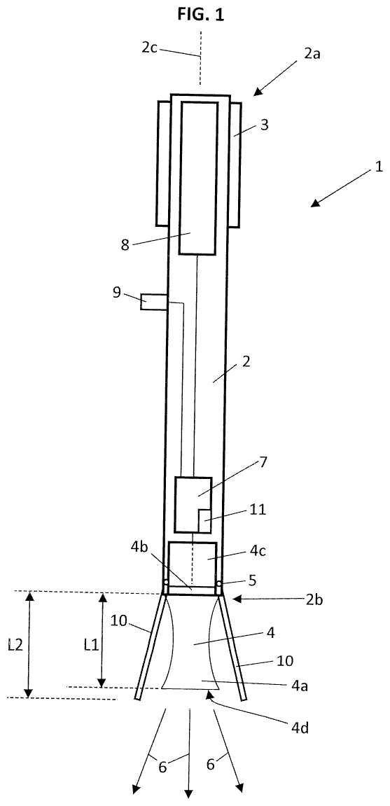

FIG. 1 schematically depicts a cross-sectional view of a toilet cleaning tool 1 according to an embodiment of the invention. The toilet cleaning tool 1 includes an elongated handle 2 with a grip 3 at one free end 2a of the handle 2 to hold the handle 2 in a hand, and a vibration member 4 at an opposite free end 2b of the handle 2.

The handle 2 has a longitudinal axis 2c, in this embodiment extending over its entire length. However, designs of the handle may be such that it is partially bend or a portion extends in a different direction. In such cases, the longitudinal axis 2c referred to in this description is the local longitudinal axis at the free end 2b, i.e. the vibration member side of the handle 2.

The vibration member 4 includes a first mass 4a, a transducer 4b, and a counter mass 4c, wherein the transducer 4b is arranged in between the first mass 4a and the counter mass 4c. A resilient connection member 5 is arranged between the counter mass 4c and the handle to connect the vibration member 4 to the handle in accordance with the third aspect of the invention.

An advantage of the resilient connection member 5 is that it may act as a damper to attenuate the vibrations from the vibration member when transferred to the handle via the resilient connection member 5. Further, the resilient connection member 5 may act as a seal, e.g. in the form of a rubber ring, between the vibration member 4 and the handle 2 to prevent water from entering the interior of the handle, e.g. to protect electronic components inside the handle 2 as explained below in more detail.

Although not depicted, alternatively, or additionally, a resilient connection member 5 may be provided between the first mass 4a and the handle 2. This resilient connection member 5, when acting as a seal, may have the advantage of protecting the transducer 4b as well as the other internal components from fluid such as water when the first mass is immerged in water.

The transducer 4b is configured to convert electrical energy to mechanical energy in the form of vibrations. The transducer 4b may be a piezoelectric transducer, e.g. a stack of piezoelectric actuators.

At a free end of the first mass 4a of the vibration member 4, the vibration member 4 includes an emitting surface 4d for transferring (and thus emitting) vibrational waves to another medium, e.g. a fluid. The vibrational waves are preferably emitted in a direction substantially parallel to the longitudinal axis 2c of the handle 2 as indicated by arrows 6.

Substantially parallel may include the emitting of vibrational waves in a cone-shape having an aperture of at most 90 degrees, preferably at most 60 degrees, more preferably at most 45 degrees, and most preferably at most 30 degrees. It is explicitly noted here that cone-shaped may include a double cone-shape in which the vibrational waves converge first and subsequently diverge. However, it is also possible that the cone-shape has an aperture close to zero degrees and thus is or is close to a cylinder.

Although the emitting surface 4d is depicted as being planar, the emitting surface 4d may be convex or concave, i.e. curved in one or two directions, e.g. resembling a portion of an inside or outside of a sphere.

The transducer 4b, and thus the vibration member 4, may be driven by a control unit 7 arranged inside the handle 2. The handle 2 may further accommodate a power source 8, in this embodiment in the form of a battery 8. The battery 8 may be rechargeable and/or replaceable for continued operation. The toilet cleaning tool 1 may include visual indicators (not shown) connected to the control unit 7, which visual indicators are used by the control unit 7 to indicate a low power level of the battery 8, so that a user is able to timely charge or replace the battery 8.

In an embodiment, the control unit 7 is configured to drive the transducer 4b with signals, e.g. electrical signals, to let the transducer 4b vibrate at a fixed frequency thereby vibrating vibration member 4. Vibration member 4, or a part thereof, e.g. first mass 4a, may have a shape, e.g. an hour-glass shape, double cone-like shape or horn shape to focus and direct the vibrations in a desired direction as indicated above.

The vibrational energy transferred to a medium, such as the water in a toilet bowl, allows to clean the toilet bowl, for instance by transferring sufficient energy to the water for cavitation to occur, which improves the cleaning performance significantly.

The toilet cleaning tool 1 may further be provided with a switch 9, in this case close to the grip 3 so that the hand holding the grip 3 is also able to operate the switch 9. The switch 9 is connected to the control unit 7 and allows to turn the vibrating of the vibration member 4 on and off.

The toilet cleaning tool 1 is further provided with one or more, in this case three, spacers 10 according to the first aspect of the invention. The spacers 10 extend from the handle 2 next to the vibration member 4 to be arranged around the vibration member 4. The spacers 10 are distributed around the vibration member to keep the vibration member 4 free of a toilet bowl during cleaning. In other words, the spacers 10 are arranged to prevent the vibration member 4 from getting into contact with a toilet bowl wall during use in at least one direction, preferably in two directions, and more preferably in three directions.

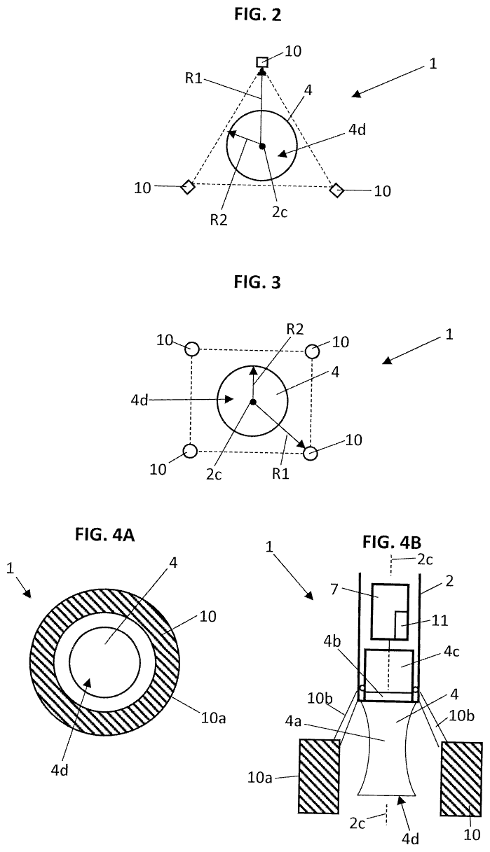

FIG. 2 depicts a bottom view of the toilet cleaning tool 1 of FIG. 1. Depicted are the vibration member 4 with emitting surface 4d and around the vibration member 4, the free ends of the three spacers 10. The spacers 10 define a triangular shape as indicated in FIG. 2 by the dashed line, which has a circle inscribed in the circumscribed triangle, which inscribed circle is larger than the emitting surface 4d. Generally speaking, the one or more spacers 10 define a circumscribed polygon and the emitting surface 4d is arranged inside a circle inscribed in the polygon. This may be applicable to any polygon. As an example, a bottom view of a toilet cleaning tool 1 according to another embodiment of the invention is depicted in FIG. 3. A difference with the embodiment of FIGS. 1 and 2 is that in this embodiment four spacers 10 are provided around the emitting surface 4d of a vibration member 4 forming a square circumscribed polygon. Again, the emitting surface 4d is arranged inside a circle inscribed in the square indicated by the dashed lines in FIG. 3.

The spacers 10, although maybe small in size and/or limited in number, act as a guard for the vibration member 4. Hence, walls of a toilet bowl, which are most of the time planar or concave, are not able to protrude into the circumscribed polygon defined by the one or more spacers 10 and thus the one or more spacers efficiently prevent said walls from getting into contact with the vibration member 4. This makes cleaning easier as a user does not have to worry about properly handling the toilet cleaning tool 1 to prevent said contact but can rely on the one or more spacers 10 to prevent said contact.

In an embodiment, the one or more spacers 10 are provided at a larger radius R1 from a longitudinal axis 2c of the handle 2 than a radius R2 of the emitting surface. In other words, the one or more spacers are configured to prevent sideways contact between toilet bowl and vibration member 4.

In an embodiment, as shown in FIG. 1, the one or more spacers 10 extend from the handle 2 beyond the emitting surface 4d in a direction parallel to a longitudinal axis 2c of the handle 2. In other words, the vibration member 4 extends over a length L1 from the handle 2 while the one or more spacers 10 extend over a length L2 from the handle 2, wherein L1 is smaller than L2.

In an embodiment, the vibration member 4 defines an emitting bundle of vibrational waves, which is the volume in which at least 90 percent, preferably at least 95 and more preferably at least 97 or 99 percent of the vibrational energy is contained. Preferably, the one or more spacers 10 are arranged outside said emitting bundle of vibrational waves, so that the presence or absence of the one or more spacers does not significantly influence the cleaning performance of the vibrational waves.

FIG. 4A and FIG. 4B schematically depict a toilet cleaning tool 1 according to a further embodiment of the invention. FIG. 4B depicts a lower portion of the toilet cleaning tool 1, wherein the upper portion may be equal or similar to the upper portion of the toilet cleaning tool 1 of FIGS. 1 and 2. FIG. 4A depicts a bottom view of the toilet cleaning tool 1 of FIG. 4B.

Depicted in FIGS. 4A and 4B are a handle 2, a vibration member 4 with a first mass 4a, a transducer 4b, a counter mass 4c, an emitting surface 4a, a control unit 7, and a spacer 10. The spacer 10 includes a ring member 10a connected to the handle 2 via multiple connecting beams 10b. The ring member 10a fully surrounds the vibration member 4.

The ring member 10a, but possibly also other portions of the spacer 10, is preferably replaceable, allowing for instance to replace the ring member 10a after some time period of use thereby ensuring a high hygiene standard for the toilet cleaning tool 1. As the ring member 10a may come into contact with biological debris before being cleaned by the vibration member 4 of the toilet cleaning tool 1, the one or more spacers 10 are likely to get dirty and may not be cleaned as easily as other portions. Replacing may then be an alternative solution to cleaning of the one or more spacers.

In an embodiment, the one or more spacers, e.g. the ring member 10a, is provided with bristles allowing to use these bristles to clean as well. As such, a combination of ultrasonic cleaning as well as cleaning using the bristles comes available to the user. The ultrasonic cleaning may be used when the vibration member 4 is submerged into water of the toilet bowl, while the bristles may be used for other parts of the toilet bowl. The bristles preferably extend sideways in a direction substantially perpendicular to the longitudinal axis of the handle 2.

The one or more spacers 10, especially when they are at least partially replaceable, may include a fragrance element providing a fragrance. The fragrance element may be part of the replaceable portion of the one or more spacers, so that the fragrance element is replaceable as part of the replaceable portion of the one or more spacers, e.g. by providing the fragrance element on the ring member 10a.

In an embodiment, the ring member 10a in FIG. 4A and FIG. 4B is replaceable by a new ring member according to the fourth aspect of the invention. The new ring member can be positioned over the handle at the grip side of the handle 2, i.e. at the free end 2a, and moved downwards into engagement with the connection elements 10b. The engagement, possibly after exerting some pressure, may result in the connection elements 10b being bend inwards, i.e. towards a longitudinal axis 2c, thereby releasing the present ring member 10a from the connection elements 10b. If this is done above a waste bin, the “old” and “dirty” ring member may be disposed of without touching the “old” ring member 10a. With the “old” ring member out of the way, room has been made for the new ring member to be moved downwards into engagement with the connection elements 10b until the ring member is connected to the connection elements 10b, e.g. using a snap-fit connection type. The connection elements 10b are therefore preferably resilient or resiliently connected to the handle 2.

In an embodiment, the connection elements 10b without ring member 10a are already acting as spacers, so that the toilet cleaning tool can also be used without ring member 10a.

The inventors have gained the insight that cleaning performance of the toilet cleaning tool according to the invention may be dependent on properties of the fluid it is submerged into and other environmental conditions, such as temperature, but also age and wear of the toilet cleaning tool itself.

Hence, instead of applying a fixed frequency to the transducer 4b, the toilet cleaning tool 1 may be configured to continuously or regularly adjust the frequency applied to the transducer, when in use of course, in accordance with the second aspect of the invention.

To this end, the toilet cleaning tool 1 may include a sensor, see FIG. 1 and FIG. 4B for a sensor 11 as being part of the control unit 7, that is configured to measure a parameter associated with the vibration member. This parameter should be chosen such that a resonance frequency of the vibration member 4 can be determined. The control unit 7 is then subsequently configured to determine the resonance frequency of the vibration member based on an output of the sensor 11 and to drive the vibration member 4 at the determined resonance frequency.

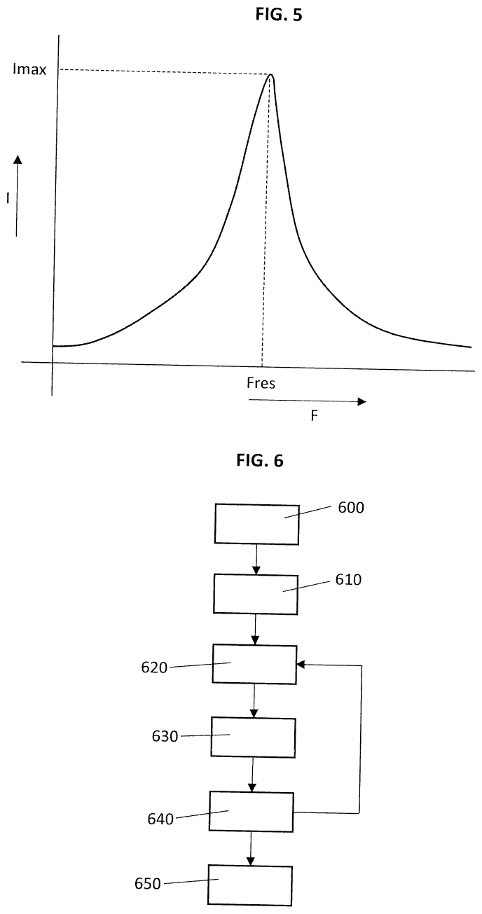

An example of such a parameter is an electrical current supplied by the control unit 7 to the transducer 4b. When the transducer 4b is a piezoelectric transducer and the control unit outputs a predetermined sinusoidal voltage signal, the current supplied by the control unit 7 to the transducer 4b may be a function of frequency of the sinusoidal signal as indicated in the diagram of FIG. 5 in which the horizontal axis is the frequency F of the sinusoidal signal and the vertical axis is the current I. As can be seen in FIG. 5, the current has a maximum Imax for a resonance frequency Fres. By measuring the current using sensor 11 and looking for the maximum current, the associated resonance frequency can be determined to drive the transducer 4b.

FIG. 6 schematically depicts a flow chart of a method to determine the resonance frequency that may be applied by the control unit continuously or regularly.

In step 600, the control unit will drive the transducer at a first frequency that is preferably known to be below the resonance frequency.

In step 610, the sensor 11 is used to measure an associated current through the transducer and determine an amplitude thereof.

In step 620, the driving frequency is increased with an increment, so that in step 630, the associated current amplitude can be determined again.

In step 640, the control unit is able to compare the current settings and measurements with the previous settings and measurements and to determine whether the current amplitude is rising or falling. A rising current amplitude means that we are still on the left side of the resonance frequency, i.e. below the resonance frequency, while a falling current amplitude means that we are on the right side of the resonance frequency, i.e. above the resonance frequency.

When the current amplitude is rising, the control unit returns to step 620 to apply a further increment to the applied frequency. This repeated until the current amplitude is no longer rising, but falling, in that case, the resonance frequency has been reached or passed and the control unit is able to drive the transducer with the proper frequency that is or is close to the actual resonance frequency thereby ensuring optimal cleaning performance.

In the above embodiment, the calibration method starts at a frequency below the resonance frequency and increases the frequency to determine the resonance frequency, but it is also possible to start at a frequency above the resonance frequency and decrease the frequency in a similar way. Further, it is possible to start at a random frequency and first determine in which direction (increasing or decreasing frequency) the resonance frequency is expected and then apply the above method in the correct direction. However, it is also possible to do a frequency sweep and determine the resonance frequency only after obtaining all measurements within a predetermined frequency range.

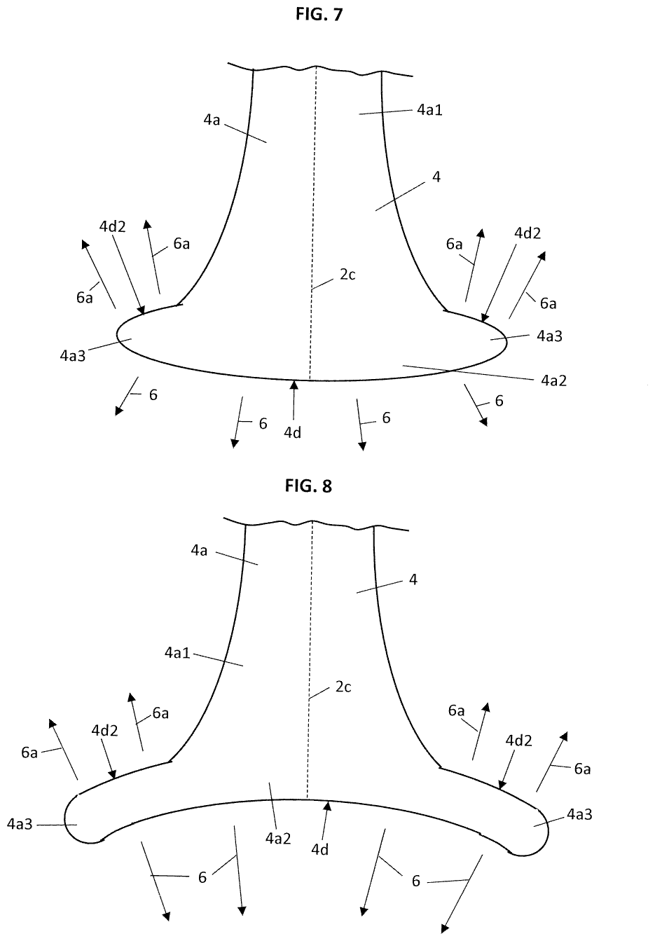

FIG. 7 schematically depicts a cross-sectional view of a free end of a vibration member 4 according to an embodiment of the invention, in particular a first mass 4a of the vibration member 4 including emitting surface 4d. Emitting surface 4d has a convex shape resulting in a diverging cone of vibrational waves as indicated by the arrows being emitted from the vibration member substantially in a first direction that is in this case parallel to a longitudinal axis 2c.

The first mass 4a includes a horn shaped portion 4a1 and a head 4a2 attached to the portion 4a1. The emitting surface 4d is part of the head 4a2. The head portion 4a2 has a side lobe 4a3 extending from the horn shaped portion 4a1 and forming a secondary emitting surface 4d2 facing substantially in an opposite direction as emitting surface 4d, which will be referred to as primary emitting surface 4d.

The secondary emitting surface 4d2 allows to emit vibrational waves in a direction substantially opposite to the first direction as indicated by arrows 6a.

FIG. 8 schematically depicts a cross-sectional view of a free end of a vibration member 4 according to another embodiment of the invention, in particular a first mass 4a of the vibration member 4 including emitting surface 4d. The embodiment of FIG. 8 is very similar with respect to the embodiment of FIG. 7 except for the difference indicated below.

A main difference is that emitting surface 4d, i.e. primary emitting surface 4d, is concave instead of convex as in FIG. 7. As a result thereof, portions of the primary emitting surface 4d opposite the secondary emitting surface 4d2 at the side lobe 4a3 are capable of running substantially parallel to each other to a high degree. Although this is also possible for the embodiment of FIG. 7 while keeping the convex shape of the emitting surface 4d by re-orienting the secondary emitting surface 4d2, the embodiment of FIG. 8 has the advantage that the vibrational waves emitted from the secondary surface 4d2 travel away from the vibration member 4 and thus do not interfere with the vibration member 4.

The shape of the head 4a2 including side lobes 4a3, e.g. a thickness of the side lobes 4a3, may be configured to emit vibrational waves of a predetermined frequency at the primary emitting surface 4d in a predetermined phase relationship with the vibrational waves emitted at the secondary emitting surface 4d2, thereby amplifying and/or attenuating each other at predetermined locations or regions.

Although in the above embodiments, typically a plurality of aspects of the invention have been combined, it will be appreciated by the skilled person that these aspects, or even features of these aspects can also be applied or used in isolation from the other features or aspects according to the invention.

1. A toilet cleaning tool comprising:
a handle;
a vibration member attached at a free end of the handle, wherein said vibration member includes an emitting surface for emitting vibrational waves;
wherein the toilet cleaning tool further includes
one or more spacers arranged around the vibration member to keep the vibration member free of the toilet bowl during cleaning.

2. A toilet cleaning tool according to claim 1, wherein the one or more spacers are provided at a larger radius from a longitudinal axis of the handle than the emitting surface.

3. A toilet cleaning tool according to claim 1, wherein the one or more spacers extend from the handle beyond the emitting surface in a direction parallel to a longitudinal axis of the handle.

4. A toilet cleaning tool according to claim 1, wherein the one or more spacers define a circumscribed polygon and the emitting surface is arranged inside a circle inscribed in the polygon.

5. A toilet cleaning tool according to claim 1, wherein the one or more spacers include a ring member.

6. A toilet cleaning tool according to claim 1, wherein the one or more spacers include bristles.

7. A toilet cleaning tool according to claim 6, wherein the bristles extend mainly perpendicular to a longitudinal axis of the handle.

8. A toilet cleaning tool according to claim 1, wherein the one or more spacers are at least partially replaceable.

9. A toilet cleaning tool according to claim 1, wherein the one or more spacers include a fragrance element.

10. A method for operating a toilet cleaning tool according to claim 1, wherein the method includes the following steps:
a. driving the vibration member to emit vibrational waves from the emitting surface; and
b. keeping the vibration member free from a toilet bowl during cleaning of the toilet bowl by allowing the one or more spacers to engage with the toilet bowl.

11. A toilet cleaning tool comprising:
a handle;
a vibration member attached at a free end of the handle, wherein said vibration member includes an emitting surface for emitting vibrational waves; and
a control unit for driving the vibration member,
wherein toilet cleaning tool comprises a sensor for measuring a parameter associated with the vibration member,
and wherein the control unit is configured to determine a resonance frequency of the vibration member based on an output of the sensor and to drive the vibration member at the resonance frequency.

12. A toilet cleaning tool according to claim 11, wherein the vibration member includes a piezoelectric transducer and the sensor is configured to measure a current supplied to the piezoelectric transducer.

13. A toilet cleaning tool according to claim 11, wherein the sensor is configured to measure strain in the vibration member as parameter.

14. A toilet cleaning tool according to claim 11, wherein the sensor is a piezoelectric transducer that is part of the vibration member and that is configured to measure deformation of the transducer as parameter.

15. A method for driving a toilet cleaning tool according to claim 11, wherein the method comprises the following steps:
a. measuring a parameter associated with the vibration member;
b. determining a resonance frequency of the vibration member based on the measured parameter; and
c. driving the vibration member at the determined resonance frequency.

16. A method according to claim 15, wherein the parameter is measured for a plurality of frequencies in a predetermined range, and the resonance frequency is determined based on the measured parameter for the plurality of frequencies.

17. A method according to claim 15, wherein the parameter is measured for a predetermined starting frequency and the frequency is adjusted in a direction in which the parameter increases, and wherein adjusting the frequency is carried out as along as the parameter increases and stops when parameter starts to decrease to determine the resonance frequency.

18. A method according to claim 15, wherein the sensor may be configured to measure a current supplied to a piezoelectric transducer that is part of the vibration member as parameter.

19. (canceled)

20. (canceled)

21. (canceled)

22. (canceled)

23. (canceled)

24. (canceled)

25. (canceled)

26. (canceled)
